(19) United States
(12) Patent Application Publication
(10) Pub. No.: US 2015/0340026 A1
(43) Pub. Date: Nov. 26, 2015

(54) EXTRACTING CANDIDATE ANSWERS FOR A KNOWLEDGE BASE FROM CONVERSATIONAL SOURCES

(71) Applicant: Palo Alto Research Center Incorporated, Palo Alto, CA (US)

(72) Inventor: John T. Maxwell, III, Santa Clara, CA (US)

(73) Assignee: Palo Alto Research Center Incorporated, Palo Alto, CA (US)

(21) Appl. No.: 14/285,117

(22) Filed: May 22, 2014

(51) Int. Cl. G10L 15/08

(52) U.S. Cl. CPC G10L 15/08

(57) ABSTRACT

A method and system is provided to extract candidate utterances from conversational data. The conversational data includes a plurality of utterances and is stored in an electronic storage. A superficial property algorithm is applied to the stored conversational data. The superficial property algorithm is used to (i) search at least a portion of the stored conversational data by application of at least one superficial property of the superficial property algorithm, (ii) it is determined when the searched portion of the conversational data includes a candidate utterance, and (iii) then the portion of the conversational data which was determined to be the candidate utterance is then stored.

### BACKGROUND

The present disclosure relates to the data processing arts, including the acquisition of data, investigation of the data, data storage and increased efficiency of operation, and the related arts.

Organizations commonly maintain electronic knowledge bases of data such as how-to articles, troubleshooting guides, among other information to assist agents or operators manning help desks, which answer user's questions about the variety of topics ranging from software, hardware, and mechanical repair, among many others. Other types of help desks provide information related to issues other than how-to subject matter such as reviews and opinions related to any of a variety of topics including but not limited to entertainment options, medical issues, and retail transactions, among others. Commonly, when a user interacts with the help desk such as by phone, e-mail, texting, or other social media or electronic communication mechanism, the agent at the help desk will commonly access the electronic knowledge base to assist in providing a useful response.

One particular source of potentially useful information is found on electronic conversational sites, such as forums, blogs, chat rooms, etc. Unlike much more structured electronic sources of information, such as a company's website, Wikipedia articles, among others which are monitored and/or edited for structure, conversational sites will have communications (hereinafter commonly called utterances) presented in a less structured presentation (e.g., commonly such sites will have a question-answer format where one party posts a question and readers of the question will post answers. The questions may be directed to how to do some task, as well as questions seeking an opinion of a product or event, or a request to confirm a fact, among many other types of inquiries.

Ways to try and identify useful information in such conversational-sites may involve computationally intense software programs which may employ artificial intelligence, as well as linguistic parsing type programs.

However as mentioned above, these types of implementations require large amounts of computational resources, lengthy processing time, and operate on the electronic computing systems inefficiently in consideration of the results being obtained and/or sought.

The present application is directed to a processing system which increases the efficiency of the processing system and obtains useful information and data applied to real world questions and situations.

### BRIEF DESCRIPTION

A method and system is provided to extract candidate utterances from conversational data. The conversational data includes a plurality of utterances and is stored in an electronic storage arrangement. A superficial property algorithm is applied to the stored conversational data. The superficial property algorithm is used to (i) search at least a portion of the stored conversational data by application of a superficial property or superficial properties of the superficial property algorithm, (ii) it then determines when a searched portion of the conversational data includes a candidate utterance, and (iii) then the portion of the conversational data which was determined to include the candidate utterance is stored in an electronic element.

In a further implementation a particular superficial property is a formatted superficial property.

In a further implementation a particular superficial property is a steps superficial property.

In a further implementation a particular superficial property is a length and copying superficial property.

In a further implementation superficial properties are applied where at least one of the applied superficial properties act as a filter of conversational data to another one of the applied superficial properties.

In a further implementation the superficial properties are used so at least two of the superficial properties are applied to a portion of the conversational data substantially simultaneously.

In a further implementation the conversational data is searched to find a question that is associated with the candidate utterance, and the question and the candidate utterance are stored as a matched pair.

In a further implementation the conversational data is searched to find an indication of perceived accuracy of the candidate utterance, and the indication of perceived accuracy and the candidate utterance are stored as a matched pair.

In a further implementation the conversational data is searched for an indication of expertise of the party providing the candidate utterance, and the indication of expertise and the candidate utterance are stored as a matched pair.

In a further implementation the conversational data is obtained by identifying subject matter of interest and conversational sites of interest.

In a further implementation the superficial property algorithm is repeated for additional portions of the stored conversational data.

In a further implementation a steps superficial property is applied to conversational data related to instructional conversational data.

In a further implementation a format superficial property is applied to opinion conversational data.

In a particular embodiment provided is a system configured to extract candidate utterances from conversational data. The system includes an electronic storage configured to store conversational data including a plurality of utterances. An electronic processing device is configured to store a superficial property algorithm designed to operate on the stored conversational data, the superficial property algorithm configured (i) to search at least a portion of the stored conversational data by application of a superficial property or superficial properties of the superficial property algorithm, (ii) to determine when the searched portion of the conversational data includes a candidate utterance, and (iii) to store the portion of the conversational data determined to be the candidate utterance in a memory storage.

### BRIEF DESCRIPTION OF THE DRAWINGS

FIG. 1 is a diagram showing an environment in which the present system and concepts are employed;

FIG. 2 shows an initial application of a superficial property algorithm (process) in which to obtain useful data in the form of useful utterances found in stored conversational data;

FIG. 3 illustrates a flow diagram portion which may be implemented in FIG. 2;

FIG. 4 depicts a flow diagram portion which may be implemented in FIG. 2;

FIG. 5 illustrates a flow diagram portion which may be implemented in FIG. 2;

FIG. 6 illustrates the use of superficial properties of the present application in a filtering type arrangement;

FIG. 7 illustrates an alternative embodiment of the application of the superficial properties according to the present application;

FIG. 8 illustrates a flow diagram which matches a candidate utterance to a question asked;

FIG. 9 illustrates an embodiment to determine if an utterance is perceived as accurate;

FIG. 10 illustrates an embodiment to determine if an utterance has been answered by an expert; and

FIG. 11 illustrates a process to obtain the conversational data stored in FIG. 2.

### DETAILED DESCRIPTION

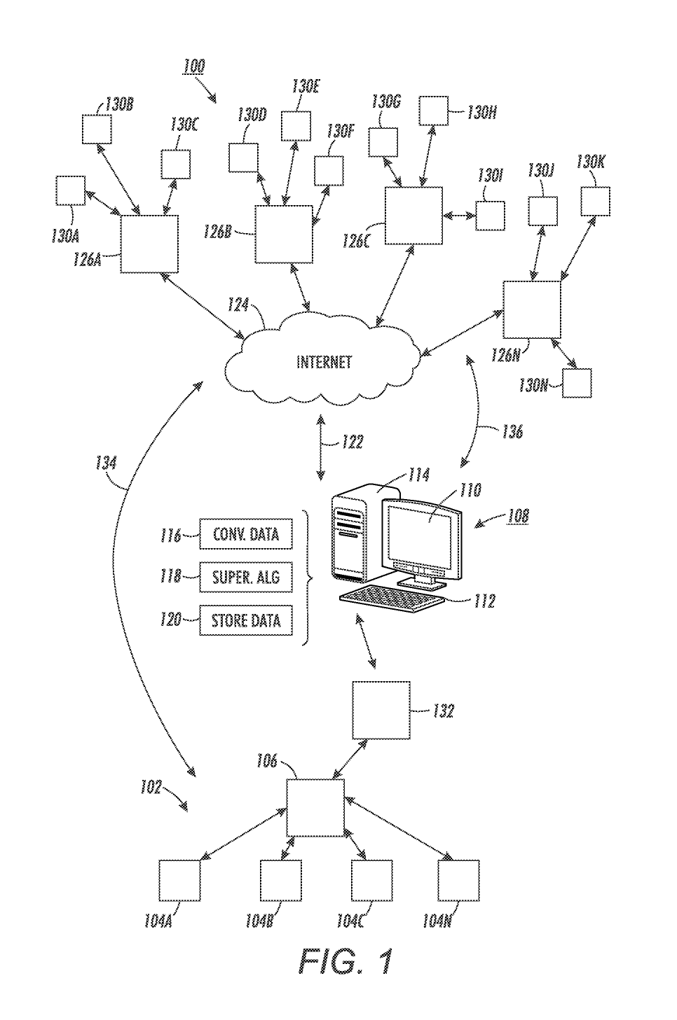

With reference to FIG. 1, depicted is an environment that includes an answer desk or helpdesk department 102, wherein helpdesk workstations 104a-104n, include some combination of desktop computers, laptops, tablet computers, phones, and smart phones as well as other communication connections including social media services. Also included is a central server 106 that contains a knowledge base (e.g. electronic database). The data within server 106 may be articles, reference manuals, among other types of data. The subject matter of the database will depend upon the nature of the help desk department 102. For example, included would be how-to articles or instructions, while in other departments there may be opinions, reviews, as well as numerous other types of material. It should be understood that help group 102 is simply an illustration, and numerous other arrangements may be employed in the context of the present teachings.

With continuing reference to FIG. 1, environment 100 is also shown to include a computing device 108 such as may be known in the art and may be commonly referred to as a computer. The illustrated computer 108 includes user interfacing components, namely, a display 110, a keyboard 112, and a computing section 114. Other user interfacing components may be provided in addition or in the alternative, such as a mouse, track ball, or other pointing device, a different help device such as a hardcopy printing device, or so forth. The computer 108 could alternatively be embodied by a network server or other digital processing device that includes a digital processor (incorporated within computer 108). The digital processor may be a single core processer, a multi core processor, a parallel arrangement of multiple cooperating processors, a graphical processing unit (GPU), a micro controller, or so forth.

With continuing reference to FIG. 1, the computer or other digital processing device 108 is configured to include memory sufficient to store data such as conversational data 116; memory and operational capabilities (e.g. processors) to operate software instructions embodying algorithms such as a superficial property algorithm 118, and additional memory and storage capabilities 120 to store output from processing of the software instructions.

The computer or other digital computing device 108 and the mentioned memory (e.g. 116, 118, and 120) may include a main memory, data memory, memory of a processor, such as the computer CPU or other computing processor, and one or more network interfaces (I/O) for communicating with other devices, all linked by a data/communication bus or buses.

Again returning to the memory or memories represented, such as 116, 118, and 120, may represent a type of non-transitory computer readable medium such as random access memory (RAM), read-only memory (ROM), magnetic disk, tape, optical disk, flash memory, holographic memory, or any other known memory or further developed memory. The network interface of the computer 108 allows for the computer to communicate with other devices via a wired or wireless links, such as a computer network, e.g. a local area network (LAN), wide area network (WAN), such as the internet, telephone line, wire connection, or combination thereof.

For example, one such communication path is represented by communication link 122 which connects computer 108 to the internet 124. As illustrated in the Figure, various other computing systems, which represent conversational data sites or sources 126a, 126b, 126c, 126n, include communication paths (un-numbered) which enable communication between these sites and computer system 108. Still alternatively, a direct connection to these sites, not via the internet, is provided as illustrated by network communication line 128 to conversational data site 126n (which is used simply as an example, and other connections such as this may also be made).

These conversational data sites 126a-126n are understood to be part of a computing system as is known in the art which allow the posting of information by third parties. These are commonly known as forums or chat rooms, where people may ask questions, and receive answers from any party with the capability of accessing the forum or chat room. In FIG. 1, the conversational sites 126a-126n, may be accessed by such third party users 130a-130n, it is these parties who will submit and/or read the conversational data communications.

Particularly, it is well known in the art that such conversational sites will have forums or chat rooms, were one of the users may leave a question about a topic of interest. Other users of the conversational site 126a-126n commonly attempt to provide an answer. In alternative conversational sites, users may be encouraged to leave comments, reviews, or opinions of any of a number of topics.

In this discussion, responses to questions (i.e. answers) and/or opinions provided regarding certain topics are commonly identified in this text as “utterances.” An utterance may be understood therefore to be a response to a question, as well as opinions or reviews. Utterances may also come to define other material submitted to a conversational site.

It is known that much of the dialogue that occurs on such conversational sites does not have significant value. Often user will simply provide an uneducated guess or an unhelpful suggestion.

It is desirable for helpdesks to review these communication sites in order to cull the valuable information and separate it from the non-valuable information. The valuable information is in this embodiment determined via processing by the computing system 108. In certain embodiments, the valuable information (“candidate utterances”) are provided a staging area 132 where human readers read what has been identified as potentially useful candidate utterances, i.e., potentially valuable answers and/or opinions, reviews, etc. Alternatively, staging area 132 may be implemented in an automated fashion, with software programs reviewing the candidate utterances to determine answers that may be appropriate for the helpdesk 102. As can be seen, the configured computer arrangement 108, acts to automatically eliminate large amounts of non-useful conversational data, thereby making the overall system more efficient, whereby if and when the software of higher complexity is employed in staging area 132, it needs to deal with potentially a magnitude of less information. Similarly, if human reviews are made, again the system is made more efficient, as again the amount of information to be reviewed has been drastically reduced.

It is also shown in FIG. 1 that the help desk components 102 may also directly access the internet 124 via line 134, and computer 108 may connect to conversational sites (e.g. 126n) by networks 136 other than via the internet.

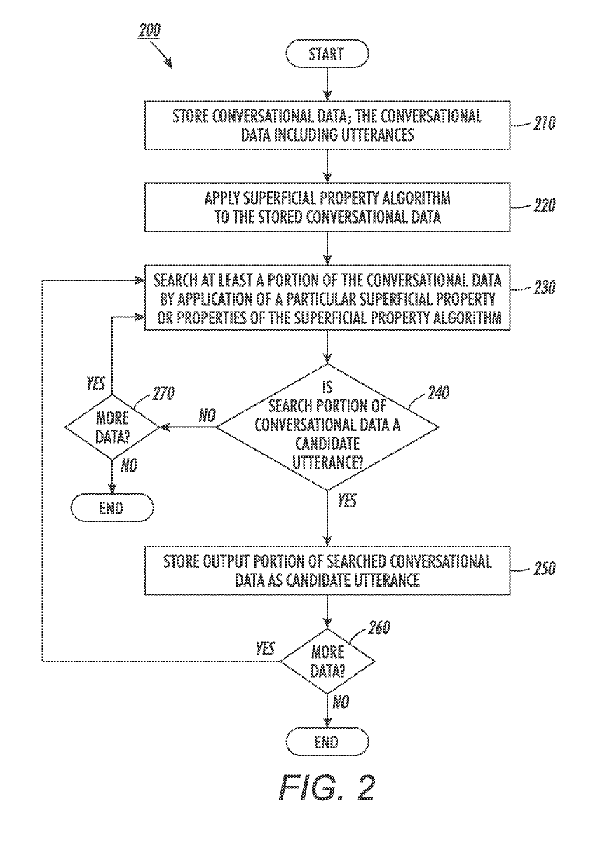

Turning to FIG. 2, illustrated is a flow diagram representing operations and processes performed in the computing system 108 to make the overall process of finding useful conversational data (i.e., utterances) more efficient.

In flow diagram 200 of FIG. 2, following the start (START), conversational data is stored within the computing system. This conversational data includes utterances that are tested to determine if such utterances are candidate utterances (step 210).

The conversational data of step 210 is then applied to a superficial property algorithm (step 220). More particularly, the superficial property algorithm searches at least a portion of the conversational data by use and application of a particular property or properties of the superficial property algorithm (step 230).

It is then determined if the searched portion of the stored conversational data includes a candidate utterance (step 240). If it is determined there is a candidate utterance in that portion of the searched conversational data (YES) then that portion (candidate utterance) is output (step 250). Thereafter, the process inquires as to whether there is additional conversational data to review (step 260), if there is additional data to be searched (YES), the process moves back to step 230, and if not (NO) the process ends.

On the other hand, if at step 240 it is determined the particular portion of conversational data being searched by the superficial property algorithm is not a candidate utterance (NO), the process moves to determine if additional conversational data is available to be searched by the superficial property algorithm (step 270), and if YES, the process returns to step 230. Alternatively, if there is no more data (NO), the process ends.

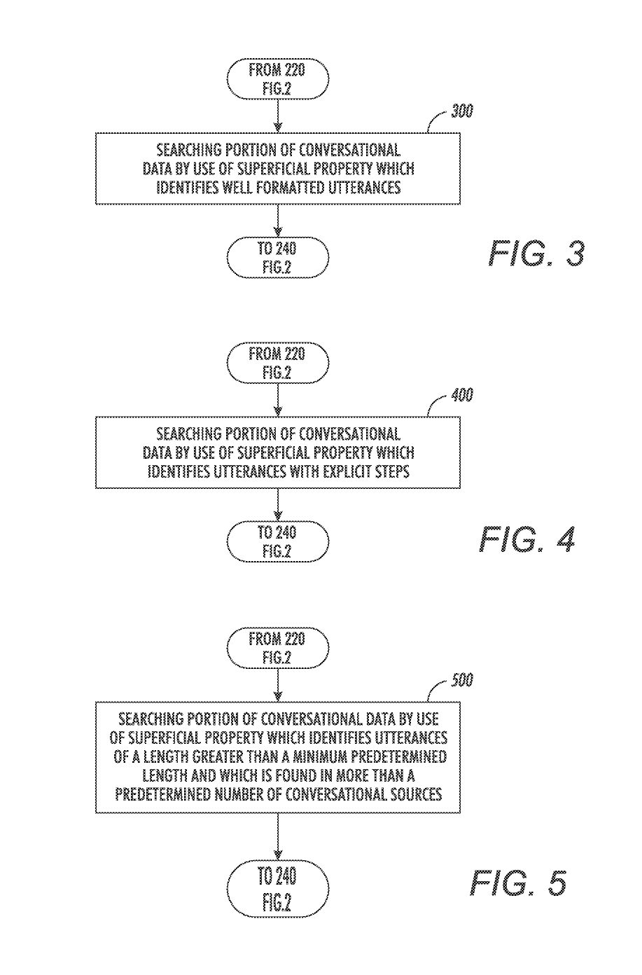

With attention to FIGS. 3, 4, and 5, more detail regarding specific superficial properties is disclosed. Particularly, while it is understood finding specific useful information that is set forth in a conversational setting (i.e., not well structured) is a difficult linguistic problem, by applying specific superficial properties as discussed herein, allows for the extraction of specific types of answers while not requiring the computational overhead that would otherwise be necessary. These properties, it has been determined, if found in a particular utterance, indicate a high probability of being related to quality answers. Specific superficial properties include:

1. Formatted Superficial Property: The utterance is well formatted (e.g., it will have at least one of bold facing, italics, bullets, indentations, quotes, and underlining).

2. Steps Superficial Property: The utterance will include language identifying explicit steps are required (i.e., Step 1, Step 2 . . . : first, second, third . . . , then . . . , and finally . . . ).

3. Length and Copying Superficial Property: The utterance is of a certain length (over X words) and has been copied nearly verbatim (i) within the same conversational site, or (ii) to a conversational site other than the original conversational site (e.g., it is found at more than a single conversational site).

An intuition behind the concept of superficial properties is that users (people) are most likely to take the time to provide formatting to high-value conversations signaling more important or more accurate knowledge. Therefore, the superficial property of being well “formatted” will search for a conversation (e.g. answer, review, opinion in a conversational data) with the formatting elements mentioned above. It is to be appreciated, the process of FIG. 3 will be tuned for a specific implementation. For example, when the superficial property is the “Formatted Superficial Property” the searching in step 240 (FIG. 2) may in one embodiment be configured to determine if the searched portion of the conversational data has a certain percentage (e.g. greater than 5%) of formatting composed to the number of words and/or numbers in the portion of conversational data being searched.

In a similar manner, the “Steps Superficial Property” of FIG. 4 is useful in finding conversational data that provides a high probability of a valuable answer, particularly to instructional or how-to type answers. Using the “Step Superficial Property” in the searching of step 240 (FIG. 2) one embodiment may determine the portion of the conversational data is a candidate utterance if the Step Superficial Property is found (e.g. the utterance includes some minimally acceptable amount of the previously mentioned “step” identifiers).

Turning to the Length and Copying Superficial Property when used in the searching step 240 of FIG. 2, the property may be tuned to the particular implementation (e.g. anything 300 words or more and copied to at least one other conversational site is a candidate utterance which when found will identify that portion of the conversational data as having a candidate utterance).

Again, the intuition as to the Length And Copying Superficial Property of FIG. 5, when utterances are long is believed, it has taken a person a significant amount of time to provide the answer and when that answer is copied and others are using it as a reference, its value is believed to increase.

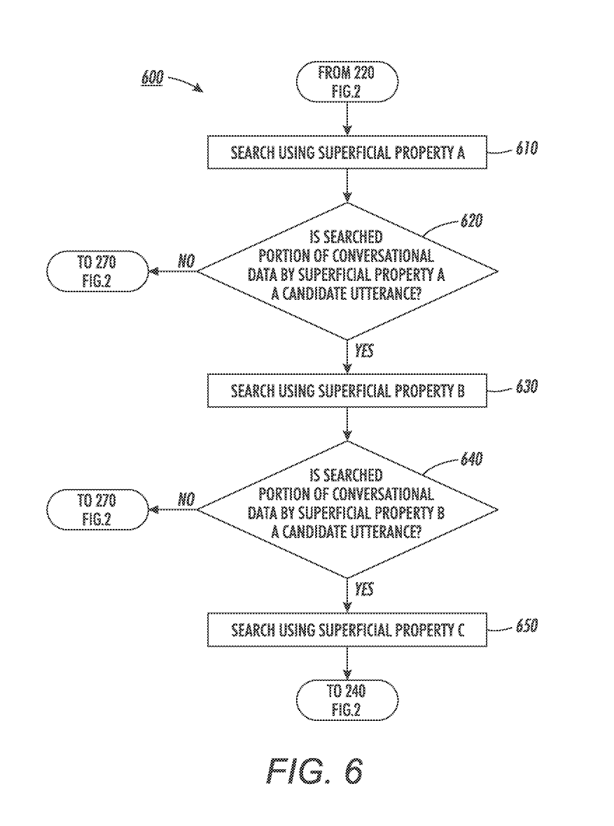

Turning to FIG. 6, provided is a flow diagram 600 which illustrates the use of superficial properties in a filtering type search process. As shown in flow diagram 600, there is superficial property A, superficial property B, and superficial property C. These properties may be, for example, any of the superficial properties discussed and illustrated in connection with FIGS. 3, 4, and 5.

Thus, generally in flow diagram 600, when the process comes from step 220 of FIG. 2, a search using the superficial property A is undertaken (step 610), this search will be of at least a portion of the conversational data to determine if that portion of conversational data includes a potential candidate utterance (step 620). If it is determined in the positive (YES), the process then implements a second search using the superficial property B (step 630). If however, back in step 620 there was no candidate utterance identified (NO), the process returns to step 270 of FIG. 2. Thus, the searching using superficial property A acts as a filter to conversational data that will not need to be searched by use of superficial property B (step 630).

Similarly, it is determined by flow diagram 600 if the potential candidate utterance from step 620 passes the threshold or requirements imposed by superficial property B (step 640), if the decision is positive (YES), the search can then move to searching using superficial property C (step 650). However if at this point, superficial property B did not identify the potential candidate utterance in the positive (NO), the process moves back to 270 of FIG. 2.

Thereafter, a search is done using superficial property C in a manner described in connection with FIG. 2. Therefore, again superficial property B acts as a filter to the searching of superficial property C.

While the foregoing describes a filtering type process using three superficial properties, is it understood such a filtering process could be used with only two of the superficial properties or more than the three. Further, again the superficial properties discussed in connection with FIGS. 3, 4, and 5 may be any of the superficial properties A, B, and C, and may be applied in any order which may be most useful for a particular implementation.

In that regard, if for example, conversational data is related to review for opinions, the Steps Superficial Property (FIG. 4) related to looking for language which identifies (step 1, step 2, step 3 . . . , etc.) would not be considered as useful in looking for utterances related to opinions or reviews, in comparison to its usefulness when questions of how-to to perform a task (i.e. instruction), which have a natural inclination to be explained in the form of steps.

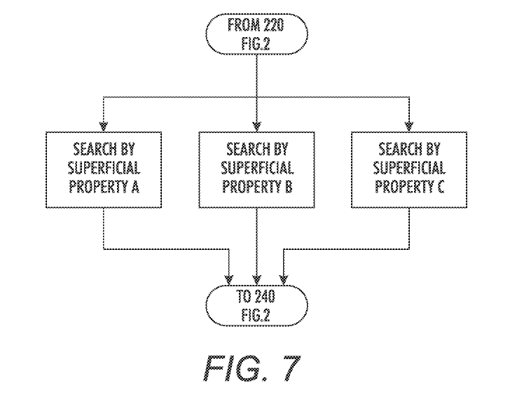

Turning to FIG. 7, illustrated is another embodiment of the present concepts. In this design, data from step 220 of FIG. 2 has superficial properties A, B, and C applied separately but in parallel. It is to be appreciated that the searching step (e.g. 240 of FIG. 2) may be designed to operate as three separate searching steps. Further, the search step may be designed to include an “at least one feature” such that if any of the searches identify the portion of conversational data as a candidate utterance then the candidate utterance will be stored (such as in step 250 of FIG. 2).

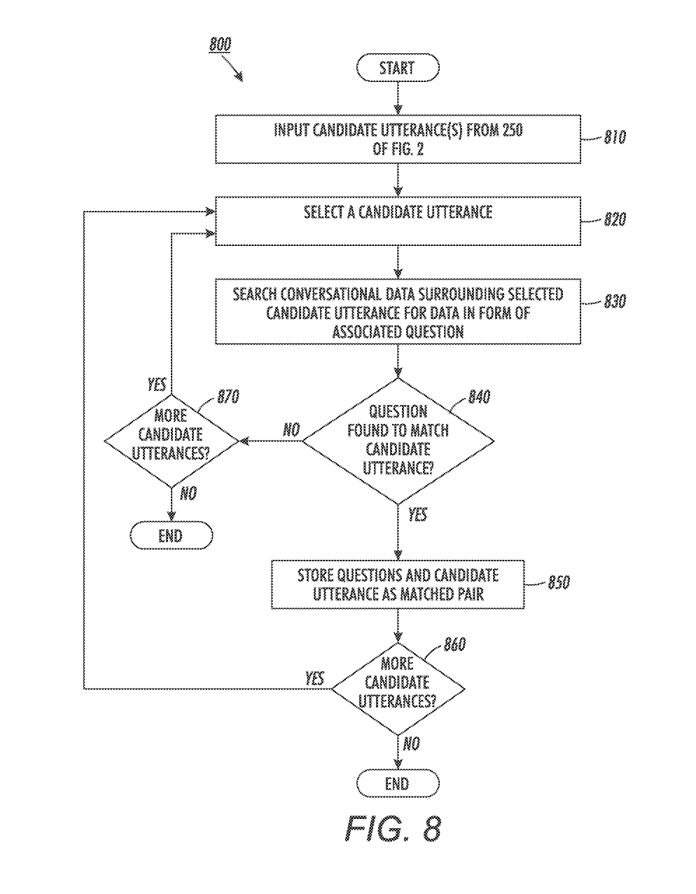

Turning to FIG. 8, illustrated is a flow diagram 800 which takes as input candidate utterances from step 250 of FIG. 2 for further processing (step 810). It is often useful to match the question to which a candidate utterance (e.g., answer, opinion, etc.) is associated. In this process, a particular candidate utterance is selected (step 820) and the process searches the conversational data surrounding the selected candidate utterance to find data in the form of a question (e.g., an associated question to the answer, opinion, etc.) (step 830). This may be done by searching the conversational data to find a heading (e.g. in a chat room or forum) that might be a “question” section; identifying an indication (i.e. “?”); and/or applying other techniques.

The process determines whether a question is found to match the candidate utterance (step 840) and when it is determined in the positive (YES), the process stores the question and candidate utterance as a match (step 850). Thereafter, the process determines if there are more candidate utterances to investigate (step 860), and if that inquiry is positive (YES), the process moves back to step 820. However, when no other candidate utterances are available (NO) the process ends. In the alternative, when at step 840 it is determined there is no question to match the candidate utterance (step 840) (NO) the process moves to again make an inquiry if more candidate utterances are available (step 870). If the answer is positive (YES) the process moves to step 820, and if the output is negative (NO) the process ends.

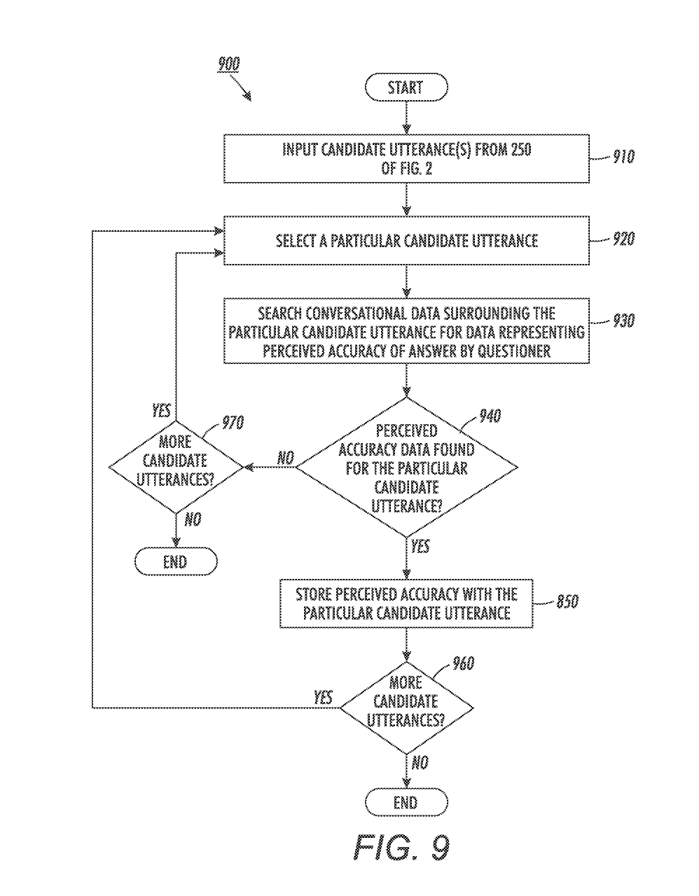

Turning now to FIG. 9, process flow diagram 900 is directed to determine if an identified candidate utterance (e.g., answer, review, etc.) has been perceived as a positive or accurate utterance. In this process, the candidate utterances from step 250 of FIG. 2 are input or stored (step 910). From this input data, a particular candidate utterance is selected (step 920). Thereafter, a search process of the conversational data surrounding the particular candidate utterance is undertaken to find data representing perceived accuracy of the utterance by the questioner (step 930). In this case, a search may be made, for example, of conversational data within a certain predetermined distance of the candidate utterance for select words, such as “great answer”, “very useful”, etc., to indicate the positive perceived nature of the candidate utterance. It is next determined whether the data is accurate (step 940). When the response is positive (YES), the perceived indication of the accuracy of the candidate utterance is stored with the candidate utterance (step 950). Thereafter, it is determined whether additional candidate utterances are stored (step 960) which when positive (YES), the process moves back to step 920, and when no additional candidate utterances exist (NO) the process ends.

If in step 940 there is no perceived accuracy data (NO) the process moves to determine if more candidate utterances are to be searched (step 970) which when positive (YES) the process again moves to step 920, and in the alternative (NO) the process ends. Also, the search step 940 may also be designed to search within a predetermined distance of the candidate utterance for select words such as “this did not help”, “not useful”, etc., to indicate the lack of a positive perceived nature of the candidate utterance.

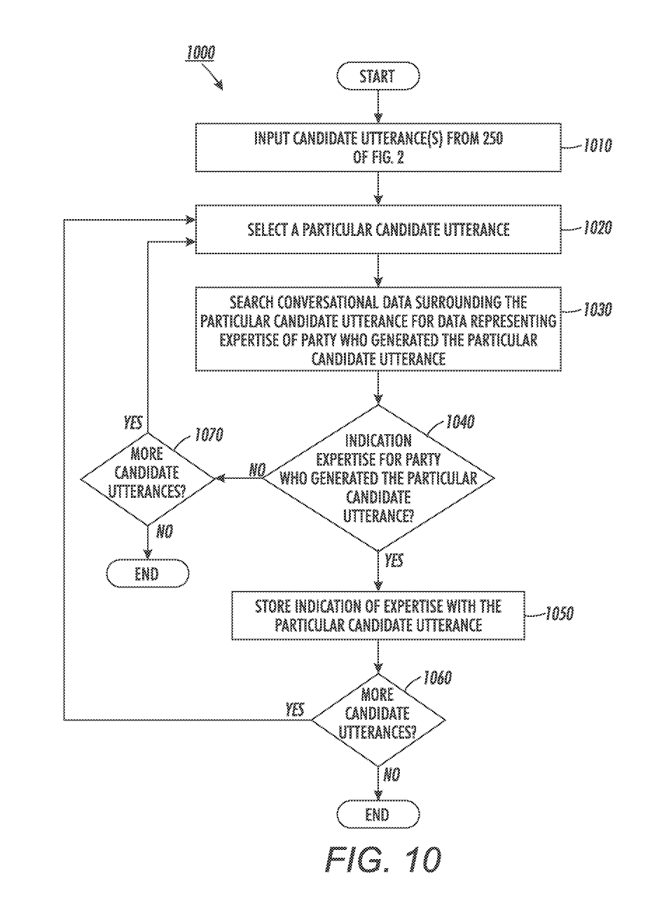

With attention to FIG. 10, a process flow 1000 illustrates the flow of matching a particular candidate utterance with a determination of the expertise of the person providing the particular candidate utterance. More particularly, the previously found candidate utterances from step 850 of FIG. 8 are stored (step 1010). The process then selects a particular candidate utterance (step 1020), and then searches the conversational data surrounding the particular candidate utterance to find data representing the expertise of the party who provided the candidate utterance (step 1030). In this embodiment, the search may look to locate any known indicators of expertise or authority (e.g. Doctor, Dr., PhD., Vice President of Engineering, CPA., Karma Points, etc.). Searching based on such parameter is then performed (step 1040). When it is determined that an indicator of expertise exists (YES), the process moves and stores the identified expertise with the particular candidate utterance (step 1050). Then the process makes an inquiry to see if more candidate utterances exist (step 1060); when this is answered in the affirmative (YES) the process moves back to step 1020. However, when the answer is in the negative (NO) the process ends.

With further attention to step 1040, if no indication of expertise is associated with the candidate utterance (NO) the process then determines if more candidate utterances are to be investigated (step 1070). When this question is answered in the positive (YES) the process moves back to step 1020, however, if the inquiry is negative (NO) the process ends.

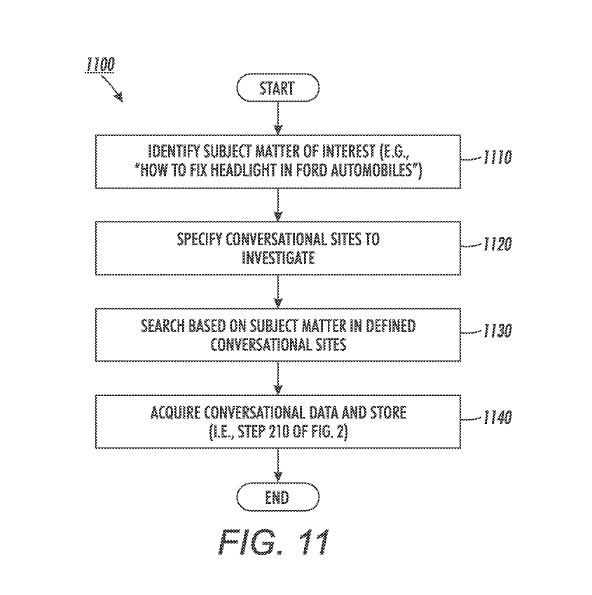

Turning to FIG. 11, it is noted that the process of FIG. 2 begins with the conversational data having been stored. This data may be acquired by a number of different processes. One particular process to obtain the conversational data is now disclosed in connection with flow diagram 1100.

More particularly, a user identifies the subject matter that is of interest (step 1110). For example, a particular inquiry related to how to fix a headlight on a ford automobile, food reviews for a certain city, or other inquiries of interest. Then the user specifies the conversational sites which are to be investigated. Particularly, the user would not normally look at a Wikipedia page or a company's website as these are well formatted, edited, and monitored sites and are not considered conversational sites as within the meaning of the present application. Thereafter, using these criteria, a search is undertaken. Such a search may use a word based search algorithm that searches the internet (e.g. Google, Yahoo, Firefox, any other known search engine) or alternatively, the system may be configured where specific conversational sites are already directly accessible by a system and these sites are then accessed via other communication channels (step 1130). The search then returns the conversational data meeting the criteria of the previous steps and it is this data that will be used in the processes such as discussed previously, including the storage of conversational data in step 210 of FIG. 2.

In alternative embodiments, the foregoing processes may assign weights to the different superficial properties. In this manner, the attributes of a specific superficial property may be emphasized over other ones of the superficial properties. For example, the superficial properties can be assigned weights based on how applicable the property is to the utterance. If the sum of the weights is below a threshold, then the utterance can be filtered.

In still another embodiment, machine learning processes may be applied to the superficial properties to improve the output results where the weighting concepts may be used.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for extracting candidate utterances from conversational data the method comprising:
storing, in an electronic storage, conversational data including a plurality of utterances; and
applying a superficial property algorithm to the stored conversational data including the plurality of utterances, the superficial property algorithm including:
(i) searching at least a portion of the stored conversational data by application at least one superficial property of the superficial property algorithm,
(ii) determining when the searched portion of the conversational data includes a candidate utterance, and
(iii) storing the portion of the conversational data determined to be the candidate utterance,
wherein the method is performed by use of at least one electronic processor.

2. The method according to claim 1 wherein a particular superficial property is a formatted superficial property.

3. The method according to claim 1 wherein a particular superficial property is a steps superficial property.

4. The method according to claim 1 wherein a particular superficial property is a length and copying superficial property.

5. The method according to claim 1 wherein the superficial properties include, a formatted superficial property, a steps superficial property, and a length and copying superficial property.

6. The method according to claim 1 further including applying the superficial properties in a configuration wherein one superficial property acts as a filter of conversational data to another superficial property.

7. The method according to claim 1 further including applying the superficial properties in a configuration where at least two of the superficial properties are applied to the portion of the conversational data substantially simultaneously.

8. The method according to claim 1 further including searching for a question that is associated with the candidate utterance, and storing the question and the candidate utterance as a matched pair.

9. The method according to claim 1 further including searching for an indication of perceived accuracy of the candidate utterance, and storing the indication of perceived accuracy and the candidate utterance.

10. The method according to claim 1 further including searching for an indication of expertise of the party providing the candidate utterance, and storing the indication of expertise and the candidate utterance.

11. The method according to claim 1 further including obtaining the conversational data by identifying subject matter of interest and conversational sites of interest.

12. The method according to claim 1 further including repeating steps (i), (ii) and (iii) for additional portions of the stored conversational data.

13. The method according to claim 1 wherein the steps superficial property is applied to conversational data related to instructional conversational data.

14. The method according to claim 1 wherein the format superficial property is applied to opinion conversational data.

15. A computer program product comprising a non-transitory recording medium wherein, when executed performs the method of claim 1.

16. A system configured to extract candidate utterances from conversational data the system comprising:
an electronic storage configured to store conversational data including a plurality of utterances;
an electronic processing device configured store a superficial property algorithm designed to operate on the stored conversational data, the superficial property algorithm:
(iv) to search at least a portion of the stored conversational data by application of a superficial property or superficial properties of the superficial property algorithm,
(v) to determine when the searched portion of the conversational data includes a candidate utterance, and
(vi) to store the portion of the conversational data determined to be the candidate utterance, in a memory storage.

17. The method according to claim 16 wherein a particular superficial property is a formatted superficial property.

18. The method according to claim 16 wherein a particular superficial property is a steps superficial property.

19. The method according to claim 16 wherein a particular superficial property is a length and copying superficial property.
